(19) United States
(12) Patent Application Publication
(10) Pub. No.: US 2026/0331511 A1
(43) Pub. Date: Oct. 22, 2026

(54) Solventless Electrodes

(71) Applicant: Celanese International Corporation, Irving, TX (US)

(72) Inventors: Victoria Black, Florence, KY (US); Cheng Wan, Shanghai (CN); Christian Ohm, Gernsheim (DE); Argiri Tsami, Kelkheim (DE); Rainer Walkenhorst, Melle (DE); Richard Moore, Florence, KY (US); Layane Deghedi, Sulzbach (DE)

(21) Appl. No.: 19/113,268

(22) PCT Filed: Oct. 9, 2023
(86) PCT No.: PCT/CN2023/123555

§ 371 Date: Mar. 19, 2025

(51) Int. Cl. H01M 4/62; H01G 9/042; H01M 4/133; H01M 4/1393; H01M 4/587

(52) U.S. Cl. CPC H01M 4/623; H01M 4/133; H01M 4/1393; H01M 4/587; H01M 4/625; H01G 9/042

(57) ABSTRACT

Electrodes for energy storage devices are disclosed that comprise a solventless electrode film. The solventless film comprises a porous network of an active material attached together by binder particles. The binder particles comprise a high density polyethylene polymer.

### BACKGROUND

Since commercial lithium ion batteries were first developed, they have been widely adopted in portable electronics such as laptops, tablets and smartphones due to their high energy density, high working voltages, and excellent flexibilities in shapes and sizes. These properties allow lithium ion batteries to accommodate demanding needs from rapidly evolving electronic devices more readily than conventional secondary batteries. Lithium ion batteries are considered as desirable alternative energy sources in emerging markets such as electrified vehicles and energy storage, which will bring about new opportunities and challenges simultaneously.

A lithium ion battery (LIB) typically comprises four components including a negative electrode (anode), a positive electrode (cathode), an electrolyte and a separator, which work in harmony to interconvert chemical energy into electrical energy reversibly as current flow reverses during charge and discharge processes. Typically electrodes are constructed by applying active material (together with additives (e.g., carbon black and carbon nanotube)) onto a current collector in the presence of a binder that affords cohesion between active materials, additives and their adhesion to the current collector. Common active materials for anodes include carbon (graphite) or silicon and, for cathodes, lithium metal oxides, mixed metal oxides, or metal salts of usually lithium or sodium. The current collector for anodes is typically copper, and for cathodes aluminum. The electrolyte can be a mixture of organic carbonates containing lithium salts. The organic carbonates can include ethylene carbonate, ethyl methyl carbonate, diethyl carbonate, or combinations thereof. The lithium salts can include LiPF₆, LiBF₄, LiAsF₆, LiClO₄, LiCF₃SO₃, LiN(SO₂CF₃)₂ or combinations thereof. The separator is commonly made from a stretched and thus micro-porous film of polyethylene or polypropylene.

Widely used binders comprise homopolymers and copolymers of polyvinylidene fluoride (PVDF), which have gained success as binders for cathodes and anodes in lithium ion battery technology. Polytetrafluoroethylene (PTFE) particles have also been used as a binder. PVDF and copolymers such as a copolymer of vinylidene fluoride and hexafluoropropylene (p(VDF-HFP)) are also used as polymer electrolytes and separators alone or in combination with other materials. PVDF might have suitable properties for lithium ion battery application such as relatively wide redox window for electrochemical stability, high molecular weight for strong adhesion to current collector and robust cohesion between active materials, high polarity to increase compatibility with polar cathode active material, proper viscosity, and commercial availability in high purity.

Recently, the use of fluorine-based polymers, however, such as PVDF and PTFE, have come under governmental scrutiny and regulations. Thus, there is currently a need to replace fluorine-based components in energy storage devices, such as lithium ion batteries. For instance, U.S. Patent Publication No. 2020/0313193, which is incorporated herein by reference, discloses a dry process for producing electrode films that are PTFE-free.

The present disclosure is directed to further improvements in the construction of electrode films and in the construction of energy storage devices, such as batteries. In one aspect, the present disclosure is directed to the construction of solventless electrodes formed through a dry process by combining a fluorine-free binder with an active material.

### SUMMARY

In general, the present disclosure is directed to electrodes for use in energy storage devices, such as batteries. The electrode can be comprised of a solventless film. The solventless film can be formed according to a dry process from an active material combined with a binder that can be formulated to be fluoropolymer-free.

For example, in one embodiment, the present disclosure is directed to an electrode for use in an energy storage device that comprises a solventless film comprising a network of an active material held together by a binder. In accordance with the present disclosure, the binder comprises at least one type of high density polyethylene polymer particles. The polymer particles are formed from a high density polyethylene having a density of about 0.92 g/cm³ or greater, such as a density of about 0.93 g/cm³ or greater. The high density polyethylene polymer particles have an average particle size (D50) of less than about 65 microns, such as less than about 40 microns, such as less than about 30 microns, such as less than about 20 microns, such as less than about 10 microns, such as less than about 8 microns, such as less than about 6 microns, such as less than about 4 microns, and generally greater than about 0.001 microns. The high density polyethylene polymer particles can comprise non-spherical particles and/or ground particles. As described above, the electrode and/or solventless film can be formulated so as to be free of fluoropolymers, such as polytetrafluoroethylene. Alternatively, the binder can comprise a high density polyethylene polymer combined with a fluoropolymer, such as polytetrafluoroethylene particles.

Electrodes made in accordance with the present disclosure can display an excellent blend of properties including good mechanical properties in combination with good electrical properties. The electrode, for instance, can display an energy density of greater than about 300 Wh/kg, such as greater than about 400 Wh/kg, such as greater than about 500 Wh/kg, and generally less than about 2,000 Wh/kg.

In addition to having a relatively small size, the high density polyethylene polymer can have a relatively high molecular weight. For instance, the high density polyethylene polymer can have a molecular weight of from about 500,000 g/mol to about 13 million g/mol, such as from about 650,000 g/mol to about 3 million g/mol.

The binder can generally be present in the solventless film in an amount from about 0.01% by weight to about 15% by weight. For instance, the binder can be present in the solventless film in an amount greater than about 0.5% by weight, such as in an amount greater than about 1% by weight, such as in an amount greater than about 1.5% by weight, such as in an amount greater than about 2% by weight, such as in an amount greater than about 2.5% by weight, such as in an amount greater than about 3% by weight, such as in an amount greater than about 3.5% by weight, and in an amount less than about 10% by weight, such as in an amount less than about 8% by weight, such as in an amount less than about 6% by weight. The electrode made in accordance with the present disclosure can be an anode or a cathode. When the electrode comprises an anode, for instance, the active material can comprise graphite. Graphite, for instance, can be present in the solventless film in an amount from about 85% by weight to about 99.99% by weight.

In one aspect, the solventless film can further comprise a conductive additive. For instance, the conductive additive can comprise carbon black or carbon nanotubes, such as multi-wall carbon nanotubes or single wall carbon nanotubes. The conductive additive can be present in the solventless film generally in an amount from about 0.01% by weight to about 5% by weight.

As described above, the high density polyethylene polymer particles can comprise ground particles and/or non-spherical particles. In one embodiment, the polyethylene polymer particles can have a multi-lobal shape. In one aspect, the binder can comprise a first type of high density polyethylene polymer particles and a second type of high density polyethylene polymer particles. The second high density polyethylene particles can have an average particle size and/or a molecular weight that is different than the first high density polyethylene polymer particles. The high density polyethylene polymer used to make the particles, in one aspect, can comprise a Ziegler-Natta catalyzed polymer.

The solventless film formed in accordance with the present disclosure can have a pore structure. For instance, the film can have a porosity of from about 10% to about 48%. The solventless film can be laminated to a current collector. The current collector, for instance, can comprise a metal foil. When constructing an anode, for instance, the metal foil can comprise a copper foil. When constructing a cathode, on the other hand, the metal foil can comprise an aluminum foil. In accordance with the present disclosure, the solventless film can display a peel strength against the current collector of greater than about 2 N/m, such as greater than about 3 N/m when tested at 180°. Peel strength can be measured according to ASTM Test D3330/D3330M.

The present disclosure is also directed to a battery, such as a lithium ion battery, containing an electrode made in accordance with the present disclosure.

The present disclosure is also directed to a process for producing a dry electrode film. The process includes blending an active material and a binder to form a dry mixture. The binder can comprise at least one type of high density polyethylene polymer particles. The polymer particles can be formed from a high density polyethylene having a density of about 0.92 g/cm³ or greater. The high density polyethylene polymer particles can have an average particle size of less than about 65 microns, such as less than about 20 microns, such as less than about 15 microns, such as less than about 10 microns, such as less than about 8 microns. Heat and pressure are applied to the dry mixture to form a solventless electrode film. For instance, in one aspect, heat and pressure can be applied to the dry mixture through a calendering process. The calendering process can be performed at a temperature of from about 100 °C to about 250 °C and a pressure from 0.1 MPa to 10 MPa

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of one embodiment of an energy storage device, such as a battery, in an exploded view that may be made in accordance with the present disclosure;

FIG. 2 is a cross-sectional view of a portion of the energy storage device illustrated in FIG. 1 showing a first electrode or cathode spaced from a second electrode or anode and separated by a porous membrane or separator;

FIG. 3 is a side view of one embodiment of a process for forming a solventless electrode film in accordance with the present disclosure;

FIG. 4 is a plan view of one embodiment of an electrode made in accordance with the present disclosure;

FIG. 5 is an enlarged view of the electrode illustrated in FIG. 4; and

FIG. 6 is another enlarged view of the electrode illustrated in FIG. 4.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to electrode films for use in constructing energy storage devices, such as batteries. Electrode films typically contain an activator material, which can be positive or negative, in combination with a binder. In the past, electrode films were made according to a wet process in which one or more solvents were combined with the active material and binder for depositing the films onto a current collector, such as a metal foil. In the past, the binders used during the process included various different fluoropolymers, such as polytetrafluoroethylene particles or polyvinylidene fluoride particles.

Recently, however, electrode fabrication has attempted to move away from a solvent-based process in addition to no longer using fluoropolymer binders. A solventless electrode process, for instance, can provide various advantages and benefits. For instance, dry electrode processes have greater throughputs and do not include a drying or solvent recovery step. Consequently, dry electrode processes consume almost 50% less energy and are more economically friendly due to the absence of the solvents.

Attempting to replace fluoropolymer materials as the binder in dry electrode processes, however, has been problematic. For instance, problems have been experienced in replacing fluoropolymers with other materials while still producing electrode films having sufficient strength, porosity, and particularly energy density.

The present disclosure is directed to producing electrode films in which the fluoropolymer binder is partially or completely replaced with a high density polyethylene. It was discovered that high density polyethylene polymer particles as a binder can provide various advantages and benefits. For instance, high density polyethylene polymers can be produced with little to no contaminants. In addition, high density polyethylene polymer particles can be used to produce both anodes and cathodes leading to greater uniformity within the energy storage device or battery. High density polyethylene polymers are also extremely inert, especially in an electrochemical cell. High density polyethylene polymers also possess excellent impact strength, abrasion resistance, and provide cold weather performance.

Of particular advantage, it was discovered that electrodes and/or electrode films containing high density polyethylene particles as a binder can display relatively high energy densities (at a rate of at least about C/20). For instance, the energy density of the battery cell can be greater than about 250 Wh/kg, such as greater than about 300 Wh/kg, such as greater than about 350 Wh/kg, such as greater than about 400 Wh/kg, such as greater than about 450 Wh/kg, such as greater than about 500 Wh/kg, such as greater than about 550 Wh/kg, such as greater than about 600 Wh/kg, such as greater than about 650 Wh/kg, such as even greater than about 700 Wh/kg, and generally less than about 2,000 Wh/kg.

Electrode films made in accordance with the present disclosure containing a high density polyethylene polymer binder can be incorporated into numerous and diverse energy storage devices. The energy storage device, for instance, can be a battery, a capacitor, or any suitable electrochemical cell. In one aspect, the electrode film can be incorporated into an ion battery, such as a lithium ion battery or a sodium ion battery. Further, the energy storage device can have any suitable configuration. The energy storage device, for instance, can be planar, can be spirally wound and/or cylindrical, or can have any other suitable shape.

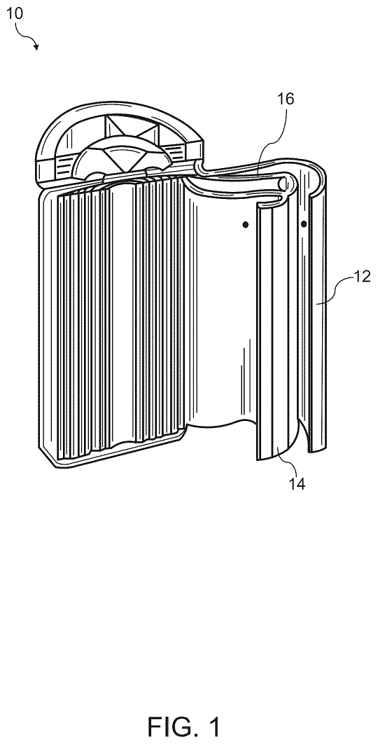

For purposes of explanation, the electrode film of the present disclosure will be described in relation to a battery, such as a lithium ion battery, as shown in FIG. 1. As illustrated, the lithium ion battery 10, in this embodiment, includes multiple layers that together produce power in terms of voltage. The battery 10, for instance, includes an anode 12 separated from a cathode 14 by a porous separator 16. The anode 12 is one of the electrodes in the battery 10 and can be made of a carbon material, such as graphite. During discharge, lithium ions move from the anode 12 to the cathode 14 through the separator 16.

The cathode 14 is the other electrode contained in the battery 10 and can comprise a lithium-containing metal oxide. The cathode 14 serves as a positive electrode during discharge.

The separator 16 is a thin, porous material placed between the anode 12 and the cathode 14 to physically separate the electrodes while allowing the flow of lithium ions. The separator 16 prevents short circuits by preventing direct contact between the two electrodes. In one embodiment, the separator 16 can comprise a porous membrane also made from high density polyethylene polymer particles. The high density polyethylene polymer, for instance, can be gel extruded into a porous membrane and incorporated into the battery 10. It is believed that incorporating high density polyethylene polymer particles into the electrodes 12 and 14 and making the separator 16 from a high density polyethylene polymer further increases the compatibility of the different components and further enhances the characteristics of the battery and the compatibility of the components.

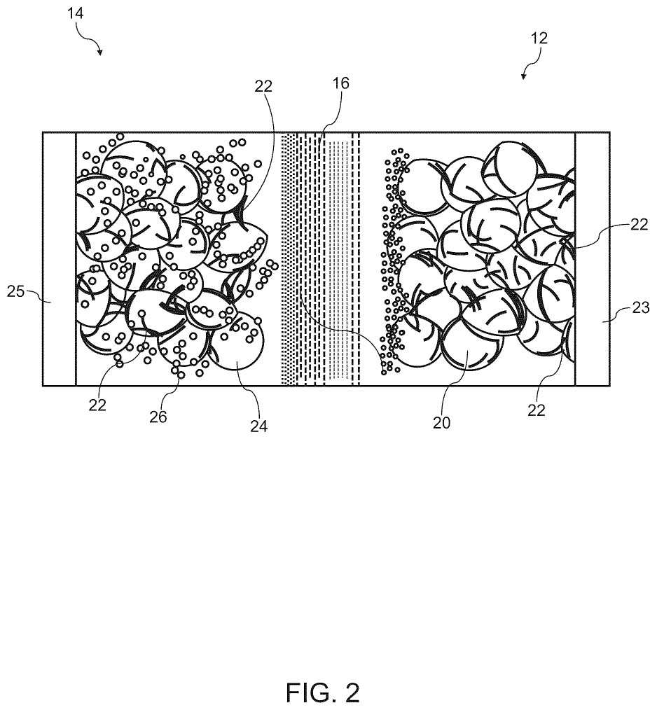

Referring to FIG. 2, a cross-section of the electrodes 12 and 14 and the separator 16 is shown. The anode 12, for instance, includes a network of an active material 20 held together by a binder 22 in accordance with the present disclosure. The active material, for instance, can comprise a carbon material while the binder 22 comprises a high density polyethylene polymer. The active material 20 and the binder 22 have been dry mixed together and formed into an electrode film under heat and pressure to form the anode 12. The anode 12 can further include a current collector 23. The electrode film made from the active material 20 and the binder 22 is laminated to the current collector 23. The current collector 23 facilitates flow of electrical current to and from the active material 20. For instance, the electrode film made from the active material 20 and the binder 22 is porous in nature. The current collector 23 serves as the substrate that can efficiently conduct electricity. When a voltage is applied to the electrode, electrons flow through the current collector, allowing the electrode to deliver or accept electrical charge. In one embodiment, the current collector 23 for the anode 12 can comprise a metal foil, such as a copper foil.

The cathode 14 also includes an active material 24 held together by the binder 22. The active material 24 in a cathode 14 may comprise, for instance, a lithium-containing material, such as a lithium-containing metal oxide. As shown, the cathode 14 can also include an additive 26. The additive 26, for instance, may comprise a conductive additive to improve the electrical conductivity of the cathode 14. The additive 26 can also comprise a lithium salt, a dopant, or an electrolyte additive.

The cathode 14 also includes a current collector 25 comprising a metal foil. For instance, the current collector 25 may comprise an aluminum foil.

The battery 10 as shown in FIGS. 1 and 2 can also include an electrolyte. The electrolyte is a chemical compound that allows for the flow of lithium ions between the anode 12 and the cathode 14 while preventing direct electrical contact between the electrodes. The electrolyte, for instance, can comprise a lithium salt dissolved in a solvent, such as a lithium hexafluorophosphate dissolved in a solvent like ethylene carbonate and/or dimethyl carbonate.

The battery 10, as shown in FIG. 1, can further include an enclosure or housing for protecting the components including the electrodes. The housing can be made from a metal or a plastic. Further, the battery 10 can include terminals on the outside of the casing or housing which are used to connect the battery to external devices or charging equipment. The battery 10 can also include a vent to prevent overcharging, over-discharging, and overheating. The vent, for instance, can comprise a passageway that allows gas to escape in the event of over pressure or thermal runaway.

Whether constructing the anode 12 or the cathode 14, a binder is used in order to hold together the active material for forming an electrode film that can then be laminated to the current collector. In accordance with the present disclosure, the binder 22 comprises high density polyethylene polymer particles.

The high density polyethylene particles incorporated into the electrode film of the present disclosure generally have a density of about 0.92 g/cm³ or greater, such as about 0.93 g/cm³ or greater, such as about 0.94 g/cm³ or greater, and generally less than about 1 g/cm³, such as less than about 0.97 g/cm³.

The high density polyethylene polymer can be made from over 90% ethylene derived units, such as greater than 95% ethylene derived units, or from 100% ethylene derived units. The polyethylene can be a homopolymer or a copolymer, including a terpolymer, having other monomeric units.

The high density polyethylene can be a high molecular weight polyethylene, a very high molecular weight polyethylene, and/or an ultrahigh molecular weight polyethylene. “High molecular weight polyethylene” refers to polyethylene compositions with an average molecular weight of at least about 3×10⁵ g/mol and, as used herein, is intended to include very-high molecular weight polyethylene and ultra-high molecular weight polyethylene. For purposes of the present specification, the molecular weights referenced herein are determined in accordance with the Margolies equation (“Margolies molecular weight”).

“Very-high molecular weight polyethylene” refers to polyethylene compositions with a weight average molecular weight of less than about 3×10⁶ g/mol and more than about 1×10⁶ g/mol. In some embodiments, the molecular weight of the very-high molecular weight polyethylene composition is between about 2×10⁶ g/mol and less than about 3×10⁶ g/mol.

“Ultra-high molecular weight polyethylene” refers to polyethylene compositions with an average molecular weight of at least about 3×10⁶ g/mol. In some embodiments, the molecular weight of the ultra-high molecular weight polyethylene composition is between about 3×10⁶ g/mol and about 30×10⁶ g/mol, or between about 3×10⁶ g/mol and about 20×10⁶ g/mol, or between about 3×10⁶ g/mol and about 10×10⁶ g/mol, or between about 3×10⁶ g/mol and about 6×10⁶ g/mol.

In one aspect, the high density polyethylene is a homopolymer of ethylene. In another embodiment, the high density polyethylene may be a copolymer. For instance, the high density polyethylene may be a copolymer of ethylene and another olefin containing from 3 to 16 carbon atoms, such as from 3 to 10 carbon atoms, such as from 3 to 8 carbon atoms. These other olefins include, but are not limited to, propylene, 1-butene, 1-pentene, 1-hexene, 1-heptene, 1-octene, 4-methylpent-1-ene, 1-decene, 1-dodecene, 1-hexadecene and the like. Also utilizable herein are polyene comonomers such as 1,3-hexadiene, 1,4-hexadiene, cyclopentadiene, dicyclopentadiene, 4-vinylcyclohex-1-ene, 1,5-cyclooctadiene, 5-vinylidene-2-norbornene and 5-vinyl-2-norbornene. However, when present, the amount of the non-ethylene monomer(s) in the copolymer may be less than about 10 mol. %, such as less than about 5 mol. %, such as less than about 2.5 mol. %, such as less than about 1 mol. %, wherein the mol. % is based on the total moles of monomer in the polymer.

In one embodiment, the high density polyethylene may have a monomodal molecular weight distribution. Alternatively, the high density polyethylene may exhibit a bimodal molecular weight distribution. For instance, a bimodal distribution generally refers to a polymer having a distinct higher molecular weight and a distinct lower molecular weight (e.g. two distinct peaks) on a size exclusion chromatography or gel permeation chromatography curve. In another embodiment, the high density polyethylene may exhibit more than two molecular weight distribution peaks such that the polyethylene exhibits a multimodal (e.g., trimodal, tetramodal, etc.) distribution. Alternatively, the high density polyethylene may exhibit a broad molecular weight distribution wherein the polyethylene is comprised of a blend of higher and lower molecular weight components such that the size exclusion chromatography or gel permeation chromatography curve does not exhibit at least two distinct peaks but instead exhibits one distinct peak broader than the individual component peaks.

The one or more polyethylene polymers incorporated into the electrode film of the present disclosure generally have a relatively high molecular weight and can be considered at least a high molecular weight polyethylene, but can also comprise a very high molecular weight polyethylene or an ultrahigh molecular weight polyethylene. The molecular weight of the one or more polymers incorporated into the electrode film, for instance, can generally be greater than about 500,000 g/mol, such as greater than about 650,000 g/mol, such as greater than about 800,000 g/mol, such as greater than about 1,250,000 g/mol, such as greater than about 1,500,000 g/mol, such as greater than about 1,750,000 g/mol, such as greater than about 2,000,000 g/mol, such as greater than about 2,250,000 g/mol, such as greater than about 2,500,000 g/mol, such as greater than about 2,750,000 g/mol, such as greater than about 3,000,000 g/mol, such as greater than about 3,250,000 g/mol, such as greater than about 3,500,000 g/mol. The molecular weight of the one or more polyethylene polymers is generally less than about 12,000,000 g/mol, such as less than about 4,500,000 g/mol, such as less than about 3,500,000 g/mol, such as less than about 3,000,000 g/mol, such as less than about 2,500,000 g/mol.

The particle size of each high density polyethylene polymer incorporated into the electrode film can influence many factors including the porous nature of the resulting product, the pore size of the resulting product, and various other properties and characteristics. In general, the average particle size (D50) (measured using laser scattering) is less than about 65 microns, such as less than about 50 microns, such as less than about 40 microns, such as less than about 30 microns, such as less than about 20 microns, such as less than about 15 microns, such as less than about 10 microns, such as less than about 8 microns, such as less than about 6 microns, such as less than about 5 microns, such as less than about 4 microns, such as less than about 3 microns.

For instance, in one embodiment, the binder particles made from the high density polyethylene polymer have a size that is comparable to the size of the active material particles. For instance, the size of the high density polyethylene polymer particles can be within about 50% (±), such as within about 30%, such as within about 20%, such as within about 10% of the size of the active material particles. Alternatively, the binder particles can be much smaller in size than the active material particles. For instance, the binder particles can have an average particle size that is 50% less, such as 60% less, such as 70% less, such as 80% less than the size of the active material particles. The average particle size is generally greater than about 0.001 microns, such as greater than about 0.5 microns, such as greater than about 1 micron.

In addition to particle size, the particle morphology of the high density polyethylene particles can also be controlled or selected for producing optimum results. By selecting a particular catalyst and the reaction conditions, the particle morphology can be changed and controlled. The particles can be spherical or non-spherical. In one aspect, for instance, high density polyethylene particles can be selected that do not have a spherical shape. For example, the sphericity of the particles can be measured by measuring the aspect ratio from the largest diameter and smallest diameter of each particle that can determined from an image. Non-spherical particles, for instance, can have an aspect ratio of greater than about 1.2, such as greater than about 1.3, such as greater than about 1.4, such as greater than about 1.5. Alternatively, non-spherical particles can be obvious from their appearance. The particles, for instance, can have a multi-lobal shape. For instance, the particles can have a “popcorn-like” shape. Using multi-lobal particles can improve the porosity characteristics and can be selected in order to maximize the amount of active material incorporated into the product.

Alternatively, the high density polyethylene polymer particles can be spherical. For instance, the particles can have an aspect ratio of less than about 1.2, such as less than about 1.1, such as less than about 1.05, and greater than about 1.

As described above, in one embodiment, relatively small particles are used. At relatively low particle sizes, the high density polyethylene polymer particles can be ground to size or can be produced through a chemical process in which the polyethylene polymer is combined with a surfactant and heated causing very small particles to precipitate after cooling. When the particles are ground, any suitable grinding technique can be used, such as jet mill grinding or the particles can be cryogenically ground. In still another aspect, the high density polyethylene particles can be fed through a sieve in order to obtain only the smallest particles in the particle size distribution.

The bulk density of the one or more high density polyethylene particles can also influence the final characteristics and properties of the electrode film. For instance, the bulk density of the polyethylene particles can be less than about 0.34 g/cc, such as less than about 0.32 g/cc, such as less than about 0.3 g/cc, and generally greater than about 0.2 g/cc, such as greater than about 0.24 g/cc, such as greater than about 0.26 g/cc. In other embodiments, however, higher bulk densities may be used. For instance, the bulk density can be greater than about 0.34 g/cc, such as greater than about 0.36 g/cc, such as greater than about 0.38 g/cc, and generally less than about 0.5 g/cc, such as less than about 0.4 g/cc. Bulk density can be measured according to ISO Test 60 or DIN Test 53466.

In one embodiment, the binder of the present disclosure is formed from two or more different high density polyethylene polymers. For example, in one embodiment, high density polyethylene polymers having different particle sizes can be used in order to control and influence the porosity of the electrode film and/or the pore size. For example, in one embodiment, the electrode film can be formed from a first high density polyethylene polymer having a first average particle size and a second high density polyethylene polymer having a second average particle size. The first average particle size, for instance, can be smaller than the second average particle size.

In other embodiments, the first high density polyethylene polymer can have a lower bulk density than the second high density polyethylene polymer. In addition, the molecular weight of each polyethylene polymer can be different. For instance, the first high density polyethylene polymer can have a molecular weight that is less than about 10%, such as less than about 20%, such as less than about 30%, such as less than about 40%, such as less than about 50%, such as less than about 60%, such as less than about 70% of the molecular weight of the second high density polyethylene polymer, or vice versus.

The relative amount between the first high density polyethylene polymer and the second high density polyethylene polymer contained in the electrode film can depend on numerous factors. For example, the weight ratio between the first high density polyethylene polymer and the second high density polyethylene polymer can be from about 10:1 to about 1:10. In one embodiment, the first high density polyethylene polymer can be present in an amount greater than the second high density polyethylene polymer. For instance, the first high density polyethylene polymer can be present in an amount greater than about 50%, such as in an amount greater than about 60%, such as in an amount greater than about 70%, and generally in an amount less than about 90%, such as in an amount less than about 80%, such as in an amount less than about 70% based upon the total weight of all polyethylene polymers present in the electrode film.

Any method known in the art can be utilized to synthesize the polyethylene polymers. The polyethylene powder is typically produced by the catalytic polymerization of ethylene monomer or optionally with one or more other 1-olefin co-monomers, the 1-olefin content in the final polymer being less or equal to 10% of the ethylene content, with a heterogeneous catalyst and an organo aluminum or magnesium compound as cocatalyst. The ethylene is usually polymerized in gaseous phase or slurry phase at relatively low temperatures and pressures. The polymerization reaction may be carried out at a temperature of between 50 °C and 100 °C and pressures in the range of 0.02 and 2 MPa.

The molecular weight of the polyethylene can be adjusted by adding hydrogen. Altering the temperature and/or the type and concentration of the co-catalyst may also be used to fine tune the molecular weight. Additionally, the reaction may occur in the presence of antistatic agents to avoid wall fouling and product contamination.

Suitable catalyst systems include but are not limited to Ziegler-Natta type catalysts and/or metallocene catalysts. Typically Ziegler-Natta type catalysts are derived by a combination of transition metal compounds of Groups 4 to 8 of the Periodic Table and alkyl or hydride derivatives of metals from Groups 1 to 3 of the Periodic Table. Transition metal derivatives used usually comprise the metal halides or esters or combinations thereof. Exemplary Ziegler-Natta catalysts include those based on the reaction products of organo aluminum or magnesium compounds, such as for example but not limited to aluminum or magnesium alkyls and titanium, vanadium or chromium halides or esters. The heterogeneous catalyst might be either unsupported or supported on porous fine grained materials, such as silica or magnesium chloride. Such support can be added during synthesis of the catalyst or may be obtained as a chemical reaction product of the catalyst synthesis itself.

In one embodiment, a suitable catalyst system could be obtained by the reaction of a titanium(IV) compound with a trialkyl aluminum compound in an inert organic solvent at temperatures in the range of −40 °C to 100 °C, preferably −20 °C to 50 °C. The concentrations of the starting materials are in the range of 0.1 to 9 mol/L, preferably 0.2 to 5 mol/L, for the titanium(IV) compound and in the range of 0.01 to 1 mol/L, preferably 0.02 to 0.2 mol/L for the trialkyl aluminum compound.

The titanium component is added to the aluminum component over a period of 0.1 min to 60 min, preferably 1 min to 30 min, the molar ratio of titanium and aluminum in the final mixture being in the range of 1:0.01 to 1:4.

In another embodiment, a suitable catalyst system is obtained by a one or two-step reaction of a titanium(IV) compound with a trialkyl aluminum compound in an inert organic solvent at temperatures in the range of −40 °C to 200 °C, preferably −20 °C to 150 °C. In the first step, the titanium(IV) compound is reacted with the trialkyl aluminum compound at temperatures in the range of −40 °C to 100 °C, preferably −20 °C to 50 °C using a molar ratio of titanium to aluminum in the range of 1:0.1 to 1:0.8. The concentrations of the starting materials are in the range of 0.1 to 9.1 mol/L, preferably 5 to 9.1 mol/L, for the titanium(IV) compound and in the range of 0.05 and 1 mol/L, preferably 0.1 to 0.9 mol/L for the trialkyl aluminum compound. The titanium component is added to the aluminum compound over a period of 0.1 min to 800 min, preferably 30 min to 600 min. In a second step, if applied, the reaction product obtained in the first step is treated with a trialkyl aluminum compound at temperatures in the range of −10 °C to 150 °C, preferably 10 °C to 130 °C using a molar ratio of titanium to aluminum in the range of 1:0.01 to 1:5.

In yet another embodiment, a suitable catalyst system is obtained by a procedure wherein, in a first reaction stage, a magnesium alcoholate is reacted with a titanium chloride in an inert hydrocarbon at a temperature of 50° to 100 °C In a second reaction stage, the reaction mixture formed is subjected to heat treatment for a period of about 10 to 100 hours at a temperature of 110° to 200 °C accompanied by evolution of alkyl chloride until no further alkyl chloride is evolved, and the solid is then freed from soluble reaction products by washing several times with a hydrocarbon.

In a further embodiment, catalysts supported on silica, such as for example the commercially available catalyst system Sylopol 5917 can also be used.

In one embodiment, especially when producing a relatively high molecular weight polyethylene, a metallocene-type catalyst may be used. For example, in one embodiment, two different metallocene-type catalysts can be used to produce the polyethylene polymer. For instance, the metallocene catalysts may be made from metals, such as hafnium and/or chromium.

Using such catalyst systems, the polymerization is normally carried out in suspension at low pressure and temperature in one or multiple steps, continuous or batch. The polymerization temperature is typically in the range of 30 °C to 130 °C, preferably in the range of 50 °C and 90 °C and the ethylene partial pressure is typically less than 10 MPa, preferably 0.05 and 5 MPa. Trialkyl aluminums, like for example but not limited to isoprenyl aluminum and triisobutyl aluminum, are used as co-catalyst such that the ratio of Al:Ti (co-catalyst versus catalyst) is in the range of 0.01 to 100:1, more preferably in the range of 0.03 to 50:1. The solvent is an inert organic solvent as typically used for Ziegler type polymerizations. Examples are butane, pentane, hexane, cyclohexene, octane, nonane, decane, their isomers and mixtures thereof. The polymer molecular mass is controlled through feeding hydrogen. The ratio of hydrogen partial pressure to ethylene partial pressure is in the range of 0 to 50, preferably the range of 0 to 10. The polymer is isolated and dried in a fluidized bed dryer under nitrogen. The solvent may be removed through steam distillation in case of using high boiling solvents. Salts of long chain fatty acids may be added as a stabilizer. Typical examples are calcium-magnesium and zinc stearate.

Generally a cocatalyst such as alumoxane or alkyl aluminum or alkyl magnesium compound is also employed. Other suitable catalyst systems include Group 4 metal complexes of phenolate ether ligands.

As described above, using high density polyethylene polymer particles as the binder in the electrode film can provide numerous advantages and benefits. High density polyethylene polymer, for instance, is inert and has excellent chemical resistant properties. With respect to using fluoropolymers, high density polyethylene polymers can have a greater orbital energy level and have better cyclic voltammetry properties and stability which makes the particles well suited for constructing cathodes and anodes. For instance, the high density polyethylene polymer selected as the binder can have an orbital energy level of greater than about −2 eV, such as greater than about −1 eV, such as greater than about 0 eV, such as greater than about 0.5 eV, such as greater than about 1 eV, such as greater than about 1.5 eV, such as greater than about 1.8 eV, and less than about 6 eV, such as less than about 4 eV.

The amount of binder or high density polyethylene polymer particles incorporated into the electrode film can depend upon various factors including the type of electrode being produced, the active material being combined with the binder, and the morphology of the particles. In general, the binder can be incorporated into the electrode film in an amount from about 0.01% by weight to about 15% by weight including all increments of 0.1% by weight therebetween.

For instance, the binder particles can be incorporated into the electrode film in an amount greater than about 0.3% by weight, such as in an amount greater than about 0.5% by weight, such as in an amount greater than about 0.8% by weight, such as in an amount greater than about 1% by weight, such as in an amount greater than about 1.2% by weight, such as in an amount greater than about 1.5% by weight, such as in an amount greater than about 1.7% by weight, such as in an amount greater than about 2% by weight, such as in an amount greater than about 2.2% by weight. The binder particles are generally incorporated into the electrode film in an amount less than about 10% by weight, such as in an amount less than about 8% by weight, such as in an amount less than about 6% by weight, such as in an amount less than about 4% by weight, such as in an amount less than about 3.5% by weight, such as in an amount less than about 3% by weight.

The binder can be made exclusively or only from high density polyethylene particles. Alternatively, the binder can comprise high density polyethylene particles combined with fluoropolymer particles, such as polytetrafluoroethylene particles. The fluoropolymer particles, such as PTFE particles, can be present in the binder in an amount of from about 0.1% by weight to about 99.9% by weight, such as from about 2% by weight to about 40% by weight, such as from about 5% by weight to about 25% by weight.

Once the high density polyethylene polymer particles are selected, the particles are combined with an active material and possibly other auxiliary agents and formed into an electrode film. In one aspect, the film can be a solventless film meaning that the film is formed without using a solvent. A solventless film, for instance, contains no processing solvents or processing solvent residues. The film, however, may contain atmospheric moisture.

In order to form the electrode film, in one embodiment, the binder particles can be combined with active material particles and first dry mixed together. After dry mixing, the particles can be subjected to heat and pressure sufficient to form a film. Heat and pressure is applied to the mixture in order for the binder particles or high density polyethylene polymer particles to flow and form an interconnected network of the active material. The resulting electrode film can be freestanding and is then laminated to a current collector, such as a metal foil.

As described above, the binder particles of the present disclosure can be used to produce anodes or cathodes. Consequently, the active material that is combined with the binder can vary depending upon the particular application.

Anode active materials can comprise, for example, an insertion material (such as carbon, graphite, and/or graphene), an alloying/dealloying material (such as silicon, silicon oxide, tin, and/or tin oxide), a metal alloy or compound (such as Si—Al, and/or Si—Sn), and/or a conversion material (such as manganese oxide, molybdenum oxide, nickel oxide, and/or copper oxide). The anode active materials can be used alone or mixed together to form multi-phase materials (such as Si—C, Sn—C, SiOx—C, SnOx—C, Si—Sn, Si—SiOx, Sn—SnOx, Si—SiOx—C, Sn—SnOx—C, Si—Sn—C, SiOx—SnOx—C, Si—SiOx—Sn, or Sn—SiOx—SnOx.).

The active material particles can be present in the electrode film in an amount from about 40% by weight to about 99.5% by weight, including all increments of 0.5% by weight therebetween. For instance, the active material contained in the electrode film to produce an anode, which can be graphite in one embodiment, can be present in the electrode film in an amount greater than about 60% by weight, such as in an amount greater than about 70% by weight, such as in an amount greater than about 80% by weight, such as in an amount greater than about 90% by weight, such as in an amount greater than about 93% by weight, such as in an amount greater than about 95% by weight.

In addition to the active material and binder, the anode film made in accordance with the present disclosure can also contain a conductive additive. The conductive additive may comprise from about 0.01% by weight to about 5% by weight of the electrode film. For instance, the conductive additive can be present in the electrode film in an amount greater than about 0.3% by weight, such as in an amount greater than about 0.8% by weight, such as in an amount greater than about 1% by weight, such as in an amount greater than about 1.2% by weight, and in an amount less than about 5% by weight, such as in an amount less than about 3% by weight. The electrode film used to form an anode may also contain various other additives.

When producing electrode films for constructing cathodes, the cathode active material can include a lithium metal oxide and/or a lithium sulfide. In some embodiments, the cathode active material may include lithium nickel manganese cobalt oxide (NMC), lithium manganese oxide (LMO), lithium iron phosphate (LFP), lithium cobalt oxide (LCO), lithium nickel manganese oxide and/or lithium nickel cobalt aluminum oxide (NCA). The cathode active material can comprise sulfur or a material including sulfur, such as lithium sulfide (Li₂S), or other sulfur-based materials, or a mixture thereof. In some embodiments, the cathode film comprises a sulfur or a material including sulfur active material at a concentration of at least 50 wt %. In some embodiments, the cathode film comprising a sulfur or a material including sulfur active material has an areal capacity of at least 10 mAh/cm². In some embodiments, the cathode film comprising a sulfur or a material including sulfur active material has an electrode film density of 1 g/cm³. In some embodiments, the cathode film comprising a sulfur or a material including sulfur active material further comprises a binder.

One or more active materials can be contained in a cathode film in an amount from about 50% by weight to about 99.5% by weight, including all increments of 0.1% by weight therebetween. For instance, one or more active materials can be contained in the cathode film in an amount greater than about 60% by weight, such as in an amount greater than about 70% by weight, such as in an amount greater than about 80% by weight, such as in an amount greater than about 90% by weight, such as in an amount greater than about 93% by weight, such as in an amount greater than about 95% by weight.

Similar to the anode, the cathode film can also contain a conductive additive comprising any of the carbon materials described above in the amounts described above. The cathode film may also contain a dopant, such as aluminum, nickel, or titanium, a lithium salt, or an electrolyte additive.

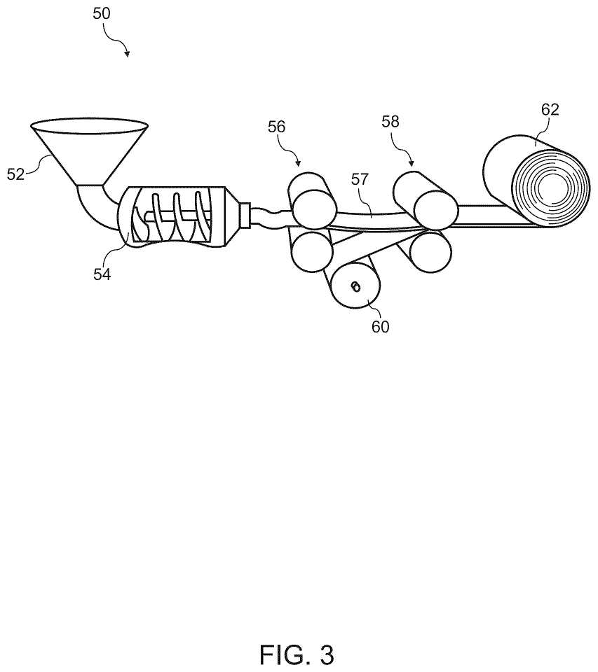

One embodiment of a process 50 for producing electrode films in accordance with the present disclosure is illustrated in FIG. 3. As shown, the high molecular weight polyethylene polymer binder particles are combined with active material particles and optionally with other additives and fed to a hopper 52. From the hopper 52, the dry mixture is blended in the mixer 54. When mixing the components together, no liquid solvents are used. The mixer can be any suitable mixer, such as a tumbler mixer, a motorized blender, or can be combined through shaking. In one embodiment, the binder and active material can be fed through a dry milling step together in order to create a homogeneous mixture and control particle size.

After being mixed, the dry mixture is subjected to heat and pressure that causes a porous film to be produced. In particular, heat and pressure are applied causing the binder particles to flow and attach together the active material particles. In this manner, a porous matrix of the active material is formed.

As shown in FIG. 3, in one embodiment, the dry mixture is fed to a calendering device 56 that comprises a pair of opposing compression rolls. One or more of the rolls can be heated. The calendering device 56 forms a nip and the dry mix of materials can be subjected to a temperature of from about 70 °C to about 250 °C. For instance, the temperature within the nip can be greater than about 100 °C, such as greater than about 125 °C, such as greater than about 150 °C, such as greater than about 175 °C, such as greater than about 185 °C, such as greater than about 200 °C, such as greater than about 205 °C, such as greater than about 210 °C, and less than about 240 °C, such as less than about 220 °C. The pressure applied within the nip can be greater than about 0.1 MPa, such as greater than about 0.5 MPa, such as greater than about 1 MPa, such as greater than about 2 MPa, such as greater than about 3 MPa, such as greater than about 4 MPa, such as greater than about 5 MPa, and less than about 10 MPa, such as less than about 9 MPa, such as less than about 8 MPa, such as less than about 7 MPa, such as less than about 6 MPa.

In one embodiment, the formed sheet or film is subjected to active cooling. For instance, the electrode film 57, as shown in FIG. 3, can be cooled to less than about 100 °C, such as less than about 80 °C, in less than about 10 mins., such as less than about 8 mins., such as less than about 5 mins.

Once the electrode film 57 is formed, the film is then fed to a laminating device 58 and laminated to a current collector 60, such as a metal foil. The laminating device may apply heat and pressure sufficient to cause the electrode film 57 to adhere to the current collector 60. In one embodiment, an adhesive or tie layer may be present on the current collector 60 for facilitating the formation of a bond between the two materials.

Not only does the high density polyethylene polymer of the present disclosure serve to hold the electrode film 57 together, but it was also discovered that the binder particles are well suited to adhering to the current collector 60. In one embodiment, in order to facilitate attachment of the electrode film 57 to the current collector 60, the current collector or a metal foil 60 can have a rough surface. For instance, the current collector 60 may have surface roughness of greater than about 200 nm, such as greater than about 240 nm, such as greater than about 260 nm, such as greater than about 280 nm, such as greater than about 300 nm, such as greater than about 320 nm, such as greater than about 340 nm, such as greater than about 360 nm, such as greater than about 380 nm, such as greater than about 400 nm, such as greater than about 420 nm, such as greater than about 440 nm, such as greater than about 480 nm, and less than about 3,000 nm when measured as an arithmetical mean height (Sa).

The electrode film 57 can be laminated to the current collector 60 in a manner that produces a relatively high peel strength. For instance, the peel strength between the electrode film 57 and the current collector 60 can be greater than about 2 N/m, such as greater than about 2.5 N/m, such as greater than about 3 N/m, such as greater than about 3.5 N/m, such as greater than about 4 N/m, such as greater than about 4.5 N/m, such as greater than about 5 N/m, such as greater than about 5.5 N/m, such as greater than about 6 N/m, and less than about 30 N/m.

Once the electrode film 57 is laminated to the current collector 60, the resulting laminate can be wound into a roll 62. Later, the laminate can be unwound, cut into strips, and fed into a process for producing energy storage devices, such as lithium ion batteries.

The basis weight of the electrode film 57 on the current collector 60 can vary depending upon the particular application. The basis weight of electrode film is generally greater than about 10 gsm, such as greater than about 20 gsm, such as greater than about 30 gsm, such as greater than about 40 gsm, such as greater than about 50 gsm, such as greater than about 60 gsm, such as greater than about 70 gsm, such as greater than about 80 gsm, such as greater than about 90 gsm, such as greater than about 100 gsm, such as greater than about 110 gsm, such as greater than about 120 gsm, such as greater than about 130 gsm, such as greater than about 140 gsm, such as greater than about 150 gsm, such as greater than about 160 gsm, such as greater than about 170 gsm, such as greater than about 180 gsm, such as greater than about 190 gsm, such as greater than about 200 gsm. The basis weight is generally less than about 500 gsm, such as less than about 450 gsm, such as less than about 400 gsm, such as less than about 350 gsm, such as less than about 300 gsm, such as less than about 275 gsm, such as less than about 250 gsm, such as less than about 225 gsm, such as less than about 200 gsm, such as less than about 175 gsm, such as less than about 150 gsm, such as less than about 125 gsm.

When incorporated into an energy storage device, such as a lithium ion battery, as described above, the anode and cathode are separated by a porous membrane or separator. In one aspect, the separator can comprise a porous membrane also made from a very high or an ultrahigh molecular weight polyethylene polymer.

An electrolyte is also contained within the energy storage device and is in contact with the anode, with the cathode, and with the separator. When the anode, cathode, and separator all contain a high density polyethylene polymer, an electrolyte can be selected that is compatible with the polymer for producing efficiencies not only in terms of mechanical properties but also in terms of electrical properties.

In one embodiment, present battery uses a suitable lithium-containing electrolyte. For example, a lithium salt, and a solvent, such as a non-aqueous or organic solvent, or fluorinated organic solvent. Generally, the lithium salt includes an anion that is redox stable. In some embodiments, the anion can be monovalent. In some embodiments, a lithium salt can be selected from hexafluorophosphate (LiPFe), lithium tetrafluoroborate (LiBF4), lithium perchlorate (LiClC) , lithium bis(trifluoromethansulfonyl)imide (LiN(SO2CFs)2), lithium trifluoromethansulfonate (USO3CF3), lithium bis(oxalate)borate (LiBOB) and combinations thereof. In some embodiments, the electrolyte can include a quaternary ammonium cation and an anion selected from the group consisting of hexafluorophosphate, tetrafluoroborate and iodide. In some embodiments, the salt concentration can be about 0.1 mol/L (M) to about 5 M, about 0.2 M to about 3 M, or about 0.3 M to about 2 M. In further embodiments, the salt concentration of the electrolyte can be about 0.7 M to about 1 M. In certain embodiments, the salt concentration of the electrolyte can be about 0.2 M, about 0.3 M, about 0.4 M, about 0.5 M, about 0.6 M, about 0.7 M, about 0.8 M, about 0.9 M, about 1 M, about 1.1 M, about 1.2 M, or any range of values therebetween.

In some embodiments, electrolytes of the present high voltage lithium-ion secondary battery invention include a liquid solvent. In further embodiments, the solvent can be an organic solvent. In some embodiments, a solvent can include one or more functional groups selected from carbonates, ethers and/or esters. In some embodiments, the solvent can comprise a carbonate. In further embodiments, the carbonate can be selected from cyclic carbonates such as, for example, ethylene carbonate (EC), propylene carbonate (PC), vinyl ethylene carbonate (VEC), vinylene carbonate (VC), fluoroethylene carbonate (FEC), methyl(2,2,2-trifluoroethyl) carbonate (FEMC) and combinations thereof, or acyclic carbonates such as, for example, dimethyl carbonate (DMC), diethyl carbonate (DEC), ethyl methyl carbonate (EMC), and combinations thereof. In certain embodiments, the electrolyte can comprise Li PF6, and one or more carbonates. An example organic solvent electrolyte includes the electrolyte known in this field as “Gen 2” electrolyte, which is 1.0 M LiPFe in ethylene carbonate (EC) and ethylmethyl carbonate (EMC), EC:EMC ratio of 3:7 by weight. In a preferred embodiment, electrolyte for use in the present high voltage lithium-ion secondary battery invention is the fluorinated organic solvent electrolyte. For example, fluorinated electrolyte referred to as FEC-FEMC, which is 1 M LiPFe in fluoroethylene carbonate (FEC) and methyl(2,2,2-trifluoroethyl) carbonate (FEMC), having an FEC:FEMC ratio of 1:9 by volume.

Electrodes and electrode films made in accordance with the present disclosure can display an excellent balance of properties in addition to a high energy density. For instance, the binder used to produce the electrode film can display a metal impurity of less than about 50 ppm and an electrochemical active impurity of less than about 100 ppm.

Electrode films made in accordance with the present disclosure can display excellent porosity characteristics in combination with high strength. The porosity of the electrode film, for instance, can be greater than about 10%, such as greater than about 20%, such as greater than about 25%, such as greater than about 30%, and less than about 60%, such as less than about 50%, such as less than about 40%, such as less than about 35%.

The electrode can display a capacity loading of greater than about 300 mAh/g, such as greater than about 325 mAh/g, such as greater than about 350 mAh/g, such as greater than about 355 mAh/g, such as greater than about 360 mAh/g, such as greater than about 365 mAh/g, such as greater than about 370 mAh/g, such as greater than about 375 mAh/g, such as greater than about 380 mAh/g, such as greater than about 385 mAh/g, such as greater than about 390 mAh/g, such as greater than about 395 mAh/g, such as greater than about 400 mAh/g, and less than about 800 mAh/g.

The above properties can be obtained at relatively small thicknesses.

The thickness of the electrode film, for instance, can be less than about 3 mm, such as less than about 2 mm, such as less than about 1 mm, such as less than about 750 microns, such as less than about 500 microns, such as less than about 450 microns, such as less than about 400 microns, such as less than about 350 microns, such as less than about 300 microns, such as less than about 290 microns, such as less than about 280 microns, such as less than about 270 microns, such as less than about 260 microns, such as less than about 250 microns. The thickness is generally greater than about 60 microns, such as greater than about 70 microns, such as greater than about 80 microns, such as greater than about 90 microns, such as greater than about 100 microns, such as greater than about 110 microns, such as greater than about 120 microns, such as greater than about 130 microns, such as greater than about 140 microns, such as greater than about 150 microns, such as greater than about 160 microns, such as greater than about 170 microns. The thickness can be varied in order to reach a targeted areal capacity, specific capacity, areal energy density, energy density, or specific energy density.

The present disclosure may be better understood with reference to the following example.

### Example No. 1

An electrode was constructed in accordance with the present disclosure. The characteristics and physical properties of the electrode were observed.

The electrode was formed from 97% by weight carbon sources and 3% by weight binder particles. The binder particles comprised an ultrahigh molecular weight polyethylene having an average molecular weight of 4,000,000 g/mol (Margolies' equation). The polyethylene particles had an average particle size (d50) of 20 microns determined by laser scattering. The polyethylene particles had a density of 950 kg/m³ (ISO Test 1183) and had a bulk density of 300 kg/m³ (ISO Test 60). The polyethylene polymer had a mass flow rate of 3.6 g/10 min at 190 °C and at a load of 21.6 kg when tested according to ISO Test 1133. The polyethylene polymer had a viscosity number of 400 cm³/g when measured according to ISO 307,1628.

The carbon sources and binder mixture were hot pressed onto a copper foil. During hot pressing, the temperature was greater than about 165 °C, such as from about 166 °C to about 185 °C, and pressure was applied in an amount of about 2.5 MPa (such as from about 2.3 MPa to about 2.8 MPa). The formed electrode was cooled while pressure in an amount of about 1 MPa (such as from about 0.8 MPa to about 1.2 MPa) was applied until the temperature reached about 100 °C

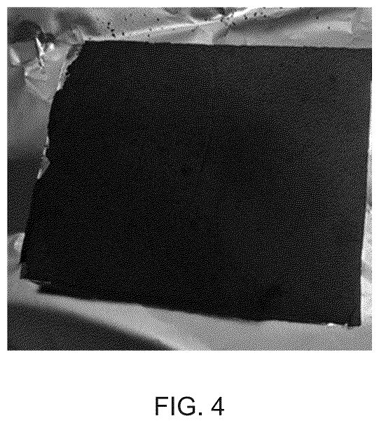

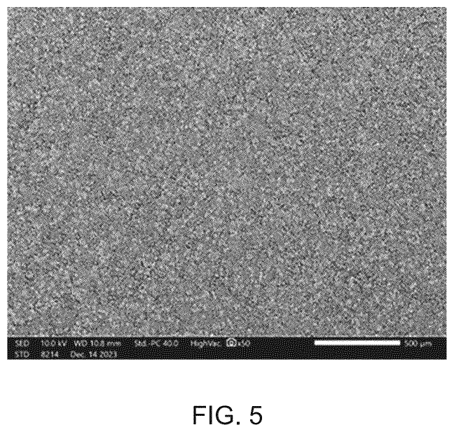

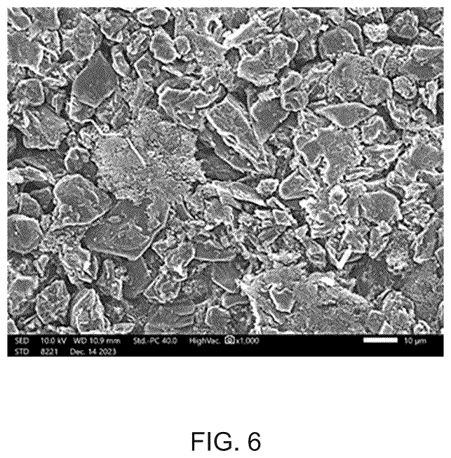

As shown in FIG. 4, the completed electrode was uniform in appearance and had a thickness of about 150 microns. Enlarged views of the electrode are shown in FIGS. 5 and 6. The electrode formed a film with sub-micron sized pores that are particularly well suited for use in batteries. After hot pressing, very small polyethylene particles having a diameter of less than about 1 micron were observed in the produced electrode.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. An electrode for use in an energy storage device comprising:
a solventless film comprising a network of an active material held together by a binder, the binder comprising at least one type of high density polyethylene polymer particles, the polymer particles being formed from a high density polyethylene having a density of about 0.92 g/cm3 or greater, the high density polyethylene polymer particles having an average particle size (D50) of less than about 65 microns and comprising non-spherical particles and/or ground particles.

2. An electrode as defined in claim 1, wherein the electrode is free of fluoropolymers.

3. An electrode as defined in claim 1, wherein the binder further comprises fluoropolymer particles.

4. An electrode as defined in claim 1, wherein a battery including the electrode displays an energy density of greater than about 250 Wh/kg,

5. An electrode as defined in claim 1, wherein the high density polyethylene polymer has a molecular weight of from about 500,000 g/mol to about 12 million g/mol.

6. An electrode as defined in claim 1, wherein the high density polyethylene polymer particles have an average particle size (D50) of less than about 40 microns.

7. An electrode as defined in claim 1, wherein the solventless film further comprises a conductive additive.

8. An electrode as defined in claim 7, wherein the conductive additive is present in the solventless film in an amount of from about 0.01% by weight to about 5% by weight.

9. An electrode as defined in claim 7, wherein the conductive additive comprises carbon black, carbon nanotubes, or mixtures thereof.

10. An electrode as defined in claim 1, wherein the high density polyethylene polymer particles have a non-spherical shape.

11. An electrode as defined in claim 1, wherein the high density polyethylene polymer particles comprise ground particles.

12. An electrode as defined in claim 1, wherein the high density polyethylene polymer particles have a multi-lobal shape.

13. An electrode as defined in claim 1, wherein the binder comprises a second type of high density polyethylene polymer particles, the second high density polyethylene particles having an average particle size (D50) and/or a molecular weight that is different than first high density polyethylene polymer particles.

14. An electrode as defined in claim 1, wherein the solventless film comprises a porous structure having a porosity of from about 10% to about 50%.

15. An electrode as defined in claim 1, wherein the binder is present in the solventless film in an amount of greater than about 0.03% by weight, and in an amount of less than about 10% by weight.

16. (canceled)

17. An electrode as defined in claim 1, wherein the active material comprises graphite.

18. (canceled)

19. An electrode as defined in claim 1, wherein the solventless film is laminated to a current collector.

20. (canceled)

21. An electrode as defined in claim 19, wherein the solventless film displays a peel strength of greater than about 2 N/m.

22. A battery comprising the electrode of claim 1.

23. A process for producing a dry electrode film comprising:
blending an active material and a binder to form a dry mixture, wherein the binder comprises at least one type of high density polyethylene polymer particles, the polymer particles being formed from a high density polyethylene having a density of about 0.92 g/cm3 or greater, the high density polyethylene polymer particles having an average particle size (D50) of less than about 65 microns and comprising non-spherical particles and/or ground particles; and
applying heat and pressure to the dry mixture to form a solventless electrode film.

24. (canceled)
